(19) United States
(12) Patent Application Publication
(10) Pub. No.: US 2026/0230827 A1
(43) Pub. Date: Aug. 6, 2026

(54) REMOTE SERVICE PROVISIONING METHOD, EMBEDDED UNIVERSAL INTEGRATED CIRCUIT CARD AND REMOTE SERVICE PROVISIONING PLATFORM

(71) Applicant: GOQUANTUM SPA, Las Condes, Santiago (CL)

(72) Inventors: Raul I. ZULETA TICCHIONE, Santiago (CL); Jose Manuel BRITO ROZAS, Santiago (CL)

(21) Appl. No.: 19/152,804

(22) PCT Filed: Feb. 22, 2023
(86) PCT No.: PCT/IB2023/051606

§ 371 Date: Jul. 31, 2025

(51) Int. Cl. H04W 12/42; H04L 9/06; H04L 9/08; H04L 9/40; H04W 12/122

(52) U.S. Cl. CPC H04W 12/42; H04L 9/0631; H04L 9/0852; H04L 63/0485; H04W 12/122; H04L 2209/80

(57) ABSTRACT

Remote service provisioning method for EUICC cards, to provide secure communication against quantum computing attacks, comprising: providing a GQ-eUICC card comprising a GQ-module, with post-quantum cryptography algorithms, and an eUICC card, generating one or more interfaces in response to connection requests to SM-DP+ and/or SM-DS service subscription servers; establishing session keys by means of post-quantum algorithms; encapsulating all the payload without modifications by means of a QIF tunnel, generated by the post-quantum cryptography algorithms; sending encapsulated communication interfaces to a QDS and/or QDP+ provisioning platform; decapsulating the encapsulated communication interfaces; establishing a connection between the QDS and/or QDP platforms and the SM-DP+ and/or SM-DS subscription servers using an i-ESx tunnel based on symmetric exchange, which encapsulates the original interfaces; establishing through an interface a secure communication between the SM-DP+ and/or SM-DS subscription servers and a service provider; and establishing a secure communication between the service provider and the eUICC.

### OBJECT OF THE INVENTION

The invention is related to the field of mobile network services and secure communications. In particular, the invention is related to authentication, identification, and protection of information against quantum computing.

An object of the invention is a remote service provisioning method for secure provisioning of profiles to a consumer device in a mobile network.

### BACKGROUND OF THE INVENTION

The world of mobile communications is very large and growing. Millions of people and devices can communicate through mobile networks, allowing the acceleration of economic activity and covering different areas of human occupation. Under the current paradigm 4G, LTE and also 5G, these communication capabilities are increasing. In this context, the ability of users and devices to authenticate and use validated credentials for their connection is essential to the reliability and security of services.

In this context, cards typically called UICC, Universal Integrated Circuit Cards are electronic modules created for the authentication of a user who wants to connect to a communications network through a mobile device.

Typically, these modules are integrated with other components to form a USIM card, Universal Subscriber Identity Module, which allows the user to authenticate with the network and receive service through a terminal.

Through these cards, the mobile operator can also identify users and their traffic, being able to monetize the corresponding service.

These cards are typically inserted into a mobile device for regular communications, although these can also be removed and used on different devices. In certain cases, users also have several USIM cards, being able to insert other cards in the same mobile device to connect to other networks and operators, and/or using other sets of credentials. Factors influencing this user behavior are, for example, the emergence or need for new, more modern mobile equipment with better or other capabilities, and/or the need for users to access service in different global regions, where other service providers or other external conditions make it necessary.

A new technology that is gaining more strength is the so-called eUICC (embedded Universal Integrated Circuit Card, also known as eSIMs (Embedded Subscriber Identity Modules) cards, which are modules that are integrated into the mobile device or equipment and are not designed to be removed or replaced, attending to new needs of the industry and users, where greater mobility of people, and connectivity of industrial equipment play a very important role.

The massification and use of eSIM technology is the enabler that allows a transparent connection between public and private networks, the latter being one of the key factors in the use and deployment of 5G worldwide.

Unlike USIM cards, which store credentials associated with a specific profile, eUICCs support multiple identity profiles, or eSIM profiles, so that the user can access different IMSI (international mobile subscriber identity) identities for each profile, so that they can authenticate with different mobile operators, without the need to replace any card.

The aforementioned profiles can be provisioned by operators using different methods based mostly on wireless communication, as suggested by the 3GPP regulatory standard for mobile communication, both for consumer type devices and for M2M devices (communication between machines). In all the above cases, the security and trust of users rests on communication protocols, in which they use adequate protection systems that prevent the impersonation or loss of credentials or information of users.

In current security protocols, the provision of credentials for devices is done securely based on different methods of exchanging cryptographic keys, which are then used to identify the devices and protect the information transmitted.

For devices using SIM cards, credential protection and authentication is primarily based on pre-shared keys (PSK Pre-Shared Keys). These secret keys are stored by the manufacturer on the card, and its complementary key is securely communicated to the service provider (mobile operator), so once the card is activated by the user, the operator can identify and provide service safely.

However, in the case of eSIM, since they are designed to be compatible with different operators, the exchange of keys is based on an asymmetric encryption method by public channel. This means that neither the user's card nor the operator has a priori information about the necessary cryptographic keys. For this, the current standard leads them to establish a secure identification and communication procedure to exchange the credentials and keys necessary to identify and protect information, which is done by an open channel (public) communication.

For this, current methods of authentication and key exchange, standard public key cryptography is used, based on algorithms such as RSA and Diffie Hellman (DH), and Diffie-Helmann with elliptic curves (ECDH) among others. These algorithms are used for the encryption of private keys and allow them to be transmitted securely through a public channel (asymmetric cryptography) and are used massively in everyday communications. Once the keys have been exchanged, a symmetric communication protocol is established based on algorithms such as AES (Advanced Encryption Standard), which are more efficient, and therefore useful for encrypting information.

Provisioning methods are known in the state of the art, for example using a signaling-based technique, or using various base nodes and Network Slicing methods to partition service nodes into normal operation segments (subscriber clients) in conjunction with provisioning segments, in order to give a temporary ‘bootstrap’ connection, to provide initial access credentials for computers that want to connect to the mobile network in service.

The methods mentioned are novel and include innovative strategies for provisioning eSIM systems. However, a key pillar of mobile communication continues to be information security. This is where the development of quantum computing plays a very important role.

Quantum computing is a technology that uses a quantum binary base or qubits (physical states represented by vectors in superposition state), instead of classical computing, based on dichotomous binary registers (0s or 1s).

Quantum computing allows superior processing capabilities than classical computing to solve some hard problems of computing based on operation simultaneously on several quantum bits, taking advantage of so-called quantum entanglement. This advantage has been illustrated by different quantum algorithms which demonstrate remarkable advantages versus their classical counterparts.

One of the most relevant examples is given by Shor's quantum algorithm. This quantum algorithm for prime number factorization allows an exponential advantage in computational time versus the fastest known classical counterpart (number field sieve, NFS).

This can strongly affect the cryptographic standards currently used for asymmetric key distribution, such as RSA, ECDH ECC, which are based on the aforementioned factorization problem (and its equivalent mathematician, the discrete logarithm problem), which could be broken in a realistic time (days, hours) by a quantum computer in a mature state, through a brute force attack. Classical computing, even using the most advanced supercomputers, could require thousands of years to break these algorithms.

This represents a serious problem, because breaking the encryption of master keys, which could be done with quantum computing, means completely compromising access to information and authentication that use keys derived from them. This affects different communications technologies, including 5G mobile communication.

The confidentiality of keys is therefore an essential issue in the context of secure communication. A fact that aggravates this problem is the use of weak cryptographic keys, given by the fact that most current systems use pseudo-random generation systems for the creation of keys. This is because even if cryptographic systems for key transmission are very robust, if the randomness is predictable (not really private), the keys can be affected. Pseudo-random generation systems are based on algorithms that possess a certain periodicity that could be used by malicious adversaries. In addition, random generation systems in general can be breached by biasing or installing backdoors (e.g. DualECDRBG).

In the case of mobile credential provisioning, this prevents the Mobile Operator from offering a reliable service to its users. A malicious third party could capture the key exchange made through OTA (over the air) under the protocols described by RSP (Remote Sim Provisioning) of ETSI/3GPP, where the transport occurs over a temporary connection either bootstrap by mobile network or WiFi. The attacker could calculate the derived keys and gain access to subscription information as well as primary control keys as well as the eSIM. Given the hierarchical architecture of the keys in the construction of this protocol, this can escalate to impact all the eSIMs belonging to the same vendor/batch etc, making the problem even more serious.

Regarding vulnerabilities, the GSMA specifies the impact of various security breaches, including the risks involved in obtaining the eSIM base cryptographic material (e.g. OTA keys, Profile, eUICC protection keys, among others) by a malicious third party, including service impairment, potential phishing, fraud and by default, loss of confidentiality and integrity in the data transmitted.

In addition to not using cryptography or reliable security methods against quantum computing, current eSIM cards use hardware components that are mostly limited to traditional cryptography, given their RAM capacity and other features. This is a problem that prevents the direct use of other types of cryptography such as post-quantum, since these generally demand much larger keys and therefore require other hardware capabilities.

Additionally, there are new cryptographic heuristics that, although they use extensive keys in size, manage to reduce the total required bytes transmitted by replacing steps in authentication and key exchange, however, these methods are not supported in current eSIMs, nor is their ability to update to these remotely installed.

Recently a technology has been discovered to provide greater security against quantum computing in the case of SIM cards, however limited to symmetric exchange protection, not extensible to asymmetric communication used in eSIM provisioning.

The adaptation to the methods just mentioned requires long periods of engineering and changes in the ways of calculating the dedicated processors, which prevents a direct deployment of other methods such as post-quantum. In addition, the standards are defined with pre-established methods that make it difficult to replace. On the other hand, more secure methods of key exchange for authentication such as QKD (Quantum Key Distribution) are currently not compatible with radio communication and/or mobile communication in the necessary frequency bands, and only allow optical communication that has other technological needs not compatible with current mobile devices, in addition it has much higher costs.

### DESCRIPTION OF THE INVENTION

The objective of the present invention is to offer a solution for remote provisioning eUICC that allows secure communication beyond current protocols and methods, in particular including quantum computing attack, which can violate existing provisioning systems, and therefore compromise the information transmitted by mobile network.

Moreover, the invention could comprise hardware elements of random generation based on quantum states for allowing the generation of more secure keys.

The method presented is flexible and practical, fulfills the current standard of eSIM provisioning and is compatible with existing technology, but also offers the advantage of providing a higher level of security.

In the longer term, the method of the invention can provide a security beyond the potential effect of quantum computing, which can represent a critical effect on the security of communications.

The invention provides a quantum-resistant remote provisioning method for eUICC cards. The eUICC (embedded Universal Integrated Circuit Card) or eSIM (Embedded Subscriber Identity Modules) cards, is an electronic module (secure element) that is designed to contain one or more subscription profiles and can be integrated into the mobile devices.

The user device is a mobile device with communication capabilities, in this particular case, compatible with eUICC technology. They can be equipment of different types, such as mobile phones, smartwatches, tablets or other devices.

The invention relates to a remote service provisioning method for embedded universal integrated circuit cards eUICC, which allows to provide secure communication against quantum computing attacks.

The method of the invention comprises a first step of providing a GQ-eUICC card. The GQ-eUICC card comprises post-quantum cryptography algorithms and also a GQ-module and an eUICC card. Preferably, the eUICC card is connected via pins of an I/O interface to the GQ-module.

The eUICC card generates one or more interfaces in response to connection requests from or to SM-DP+ and/or SM-DS service subscription servers. Then, session keys are stablished by means of post-quantum algorithms.

A message and the interfaces, i.e. all the payload, are encapsulated completely and without modifications by means of a QIF tunnel, generated by the GQ-eUICC card using post-quantum cryptography algorithms. Thus, encapsulated communication interfaces are obtained according to an interface type (ES-X) and destination.

The encapsulated communication interfaces are sent to a QDS and/or QDP+ provisioning platform, by using an IP protocol provided by a WAN or Internet access carrier.

Then, the method comprises a step of decapsulating the encapsulated communication interfaces in the QDS and/or QDP+ provisioning platform, thus, obtaining original interfaces from the encapsulated communication interfaces.

A connection between the QDS and/or QDP platforms and the SM-DP+ and/or SM-DS subscription servers is established by means of an i-ESx tunnel based on symmetric exchange. The i-ESx tunnel encapsulates the original interfaces and transmits them encapsulated.

Using a second interface, a communication, secure against classic and quantum computating, is established between the SM-DP+ and/or SM-DS subscription servers and a service provider containing OSS (Operator Support System), HSS (Home subscriber Service), or Service Fulfillment elements.

Then, the method comprises establishing through a third interface a secure communication between a provisioning responsible and the eUICC.

Preferably, the GQ-eUICC card provided could also comprise a quantum random number generator configured to provide randomness in the step of generating session keys by means of post-quantum algorithms.

In some embodiments, the step of generating one or more interfaces in response to connection requests from or to SM-DP+ and/or SM-DS service subscription servers could be carried out by means of an LPA (Local Profile Assistant) included in the eUICC card or in a user device comprising the eUICC card, using an encapsulated interface that enables secure communication through the QIF tunnel.

In some embodiments, the method of the invention could also comprise a step of generating one or more encapsulated interfaces, which enables secure communication through the QIF tunnel, in response to connection requests from or to the QDS platform, generated from the eUICC card. The connection requests are performed by the LPA (Local Profile Assistant) included in the eUICC card.

Preferably, the step of encapsulating the interfaces by means of a QIF tunnel is performed by a QIF Interface Wrapper logic element comprised by the GQ-eUICC card.

In the same way, in the step of sending encapsulated connection requests, the WAN or Internet access carrier could be controlled by a GQ Telecom Framework logical element comprised by an Auxiliary Functions module of the GQ-eUICC card.

In a case wherein the WAN or Internet access carrier does not achieve connectivity by itself, the connection is established by using internal carriers of the embedded eUICC card, thus, accessing to a communication layer provided by the eUICC card.

Preferably, the step of encapsulating the interfaces by means of a QIF tunnel could also include enriching interface headers to be transported by the QIF tunnel. This enrichment process would be carried out by means of a TCP-QUIC translator logical element of the GQ-eUICC card and by means of the QDS and/or QDP+ provisioning platform.

In some embodiments, the QIF tunnel could be decomposed into multiple layers. Thus, a User Datagram Protocol (UDP) channel type over Internet Protocol (IP) and a Quick UDP Internet Connections (QUIC) protocol are used for establishing a tunnel with private QUIC UDP IP headers.

Preferably, the traffic that crosses through this tunnel passes through post-quantum key exchange and authentication mechanisms provided by a QIF Interface Wrapper module of the GQ-eUICC card.

The method of the invention could be extended towards standardized and/or non-standardized post-quantum category schemes, by means of a Firmware Update Functions internal component of the GQ-eUICC card, administered and managed by the QDS and/or QDP+ provisioning platform. The Firmware Update Functions internal component implements an internal protocol in the GQ-eUICC card and in the QDS and/or QDP+ provisioning platform to allow remote updating of the cryptographic primitives through Over the Air (OTA) and/or via Quick UDP Internet Connections (QUIC).

Also, in the method of the invention, once session keys are established, symmetric encryption is initiated based on an AES, Snow5G or Snow3G algorithm.

Preferably, the cryptographic material needed to authenticate the QDS and/or QDP+ provisioning platform and to exchange keys with the GQ-eUICC card is stored in a logical element of the GQ-eUICC. Said logical element would correspond to an element of the Secure Element type and should not be accessible directly but through APIs. Also, in this logical element, writing permissions are established during manufacturing and are subjected to cryptographic control.

Also, the i-ESX tunnel, in terms of key setting, authentication and symmetric encryption, could be established using IP transport over TCP plus a traditional TLS layer or TCP plus an IPSEC layer, but using 24-hour duration keys.

The invention also relates to an embedded universal integrated circuit card GQ-eUICC, which comprises:
at least one eUICC card;
a GQ-module comprising at least one ROM, at least one SRAM synchronous memory and at least one processor; and
at least one I/O interface, which connects the at least one eUICC card to the GQ-module.

The at least one processor is connected to, and controls the at least one memory (ROM), the at least one synchronous memory (SRAM) and the at least one eUICC card. The at least one processor is also configured to perform the method of the invention previously defined.

Preferably, the eUICC card could be embedded as an iUICC card.

The embedded universal integrated circuit card GQ-eUICC of the invention could also comprise at least one QRNG randomness generating element for the generation of secure cryptographic keys based on a physical detection of quantum states and connected to the at least one processor.

The embedded universal integrated circuit card GQ-eUICC of the invention could also comprise at least one sensor, configured to detect a quantum state and connected to the at least one QRNG randomness generating element.

In some embodiments, the QRNG randomness generating element is a generator based on photonic detection, wherein the randomness is generated by detection of photons or by methods of calculating quantum entropy by light measurement.

Preferably, the QRNG randomness generating element can comprise independent device or semi-independent device strategies to decrease the chances of violation due to damage or intervention of the sensor or electronics.

The invention also relates to a remote service provisioning platform which comprises a user device with the embedded universal integrated circuit card (GQ-eUICC) of the invention as previously defined and a QDS and/or QDP+ provisioning platform with a QRNG randomness generator for secure cryptographic key generation.

### DESCRIPTION OF THE DRAWINGS

In order to complement the description being made and with the object of helping to better understand the features of the invention, in accordance with a preferred practical exemplary embodiment thereof, said description is accompanied, as an integral part thereof, by a set of drawings where, in an illustrative and non-limiting manner, the following has been represented:

FIG. 1. Shows an embodiment of the remote service provisioning platform of the invention and the connections between the elements of said remote service provisioning platform.

FIG. 2. Shows an embodiment of the remote service provisioning platform of the invention including logical elements for post-quantum protection.

FIG. 3. Shows an embodiment of the GQ-eUICC of the invention for an LPA-capable mobile device. The invention depicted contains a QRNG randomness generator.

FIG. 4. Shows an embodiment of the remote service provisioning platform including the logical modules for post-quantum protection and the interfaces generated.

FIG. 5. Shows a secure communication protocol between GQ-eUICC and QDS/QDP+.

FIG. 6. Shows two embodiments of the remote service provisioning platform of the invention with the LPA in the user's device and with the LPA included in the eUICC.

FIG. 7. Shows an embodiment of the remote service provisioning platform of the invention in a message exchange process, along as and their respective endpoints and modules related, including each network zone belongings.

FIG. 8. Shows an embodiment of the remote service provisioning platform of the invention in a network message transport encapsulation/decapsulation process form.

FIG. 9. Shows a flow diagram of an embodiment of the method of the invention.

### PREFERRED EMBODIMENT OF THE INVENTION

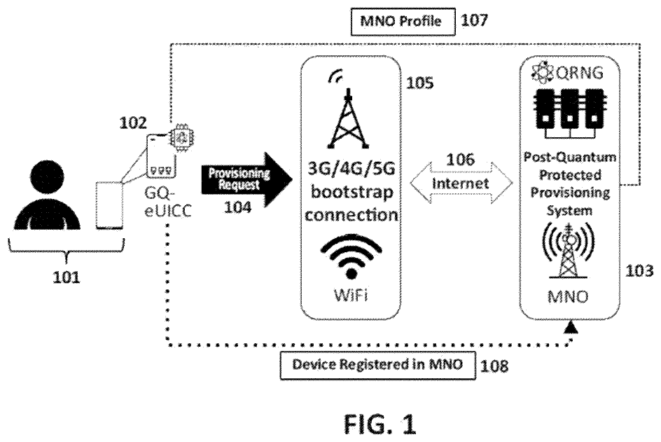

FIG. 1 shows an exemplary embodiment of the sequence in which a new user device (101) is provisioned remotely, showing a remote service provisioning platform according to the invention.

In this way, the remote service provisioning platform comprises a user device with an embedded universal integrated circuit card (GQ-eUICC) according to the present invention and a QDS and/or QDP+ provisioning platform (203). Therefore, the embedded universal integrated circuit card (GQ-eUICC) of the invention is intended to be used in a user device (101), which is compatible with standard embedded universal integrated circuit cards (eUICC).

The invention also relates to a remote service provisioning method, which follows the logic of the standard procedure, but has some key differences at the software and hardware level, thus allowing to deal with the requirements of a different additional authentication type as well as encryption and at the same time remain compatible according to traditional requirements. In this way, a complete provisioning system with post-quantum protection for the interfaces exposed to Internet is obtained.

In this example the method of the invention allows a user device (101), compatible with standard eUICC cards, and equipped with a specially designed GQ-eUICC (102) card according to the present invention, to receive remote provisioning with post-quantum protection from a central server controlled by mobile provisioning provider (103). These devices are configured for a typical use following the behavior of current eSIM communication systems, but they are safe against quantum computing attacks.

In this case, the user device (101) is new to the network, which means he is not yet subscribed nor has access to one or more of the Long-Term Evolution (LTE) or Next Radio (NR) mobile networks in service in the location where the user is located. The user device (101) request to remotely obtain provision with credentials to access to a provisioning system (103) associated with a mobile operator (MNO) and thus be able to have service.

Sequentially, user (101) performs a provisioning request (104) through a Bootstrap or WIFI (105) mobile connection, which is directed to the provisioning system (103) associated with the mobile operator (MNO) with a post-quantum (106) security. An MNO profile (107) package is securely sent to the user device (101) using the channel set and installed on that device.

Finally, the user device (101) requests connectivity for registration on the network of the mobile operator (MNO). In this way, user device (101) can establish communication with the mobile operator (MNO) network in a secure manner against quantum computing.

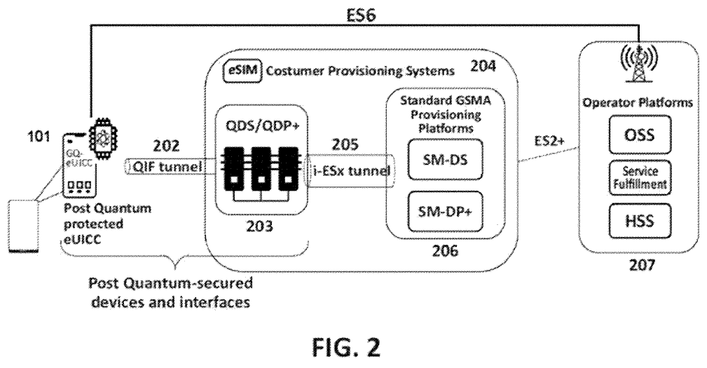

In FIG. 2, a detailed exemplary embodiment of the remote service provisioning platform of the invention is shown.

In this case, the remote service provisioning platform comprises an intermediate remote provisioning logical interface with post quantum security (QIF), and a standard provisioning interface.

The user device (101) contains a new security embedded universal integrated circuit card, called GQ-eUICC, which is also part of the invention and comprises the standard eUICC.

The embedded universal integrated circuit card (GQ-eUICC) may comprise a quantum random number generator (QRNG), to enhance the security of generated secure cryptographic keys. In particular, these generators are based on the physical detection of quantum states. These quantum random number generators (QRNG) can be generators based on photonic detection, i.e. light, by detection of single photons, quantum entropy calculation methods by light measurement, or highly secure strategies such as Device-independent and Semi-Device-Independent, which reduce the possibilities of violation due to damage to the measurement components. These devices enable high-quality random generation by hardware, which decreases the risk of identifying patterns such as that possessed by algorithm-based pseudorandom generators.

The remote provisioning system (204) of FIG. 2, comprise some subsystems, such as standard components (206) and new QDS/QDP+ elements (203), the latter being parts of the invention. Also, the remote provisioning system (204) uses the new communication logic tunnel, called QIF (202), to handle communication to and from the user device (101).

The new logical entities introduced by the present invention were designated QDS/QDP+ (203), being QDS System's Post-Quantum Provisioning Discovery Service wrapper, and QDP representing the System's Post-Quantum Provisioning Data Preparation wrapper. These entities provide communication security mechanisms, and act as part, server and terminator of the QIF (202) tunnel.

These entities subsequently implement the logical tunnel, named i-ESx (205). Through the i-ESx (205) tunnel, traditional provisioning operations related to SM-DP+ (Data Preparation server), SM-DS (Discovery Server) (206) and eUICC are performed.

In some implementations the QDS and QDP+ (203) entity can also contain a quantum random number generator element, which allows to use quantum-based random numbers in the key generation process of the post-quantum cryptographic layer, strengthening the QIF (202) tunnel.

The i-ESx (205) tunnel uses a new communication mechanism with respect to the standard, since new security and robustness features are added, given by the use of quantum generation of random numbers (QRNG) and post-quantum cryptography in communications. The i-ESx (205) tunnel is based on symmetric exchange between QDS/QDP platforms (203) and SM-DP+/SM-DS services (206), encapsulating the ES8/ES9/ES11 interfaces in an internal interface.

Finally, the provisioning system (204) communicates through the ES2+ interface with the operator platform (207), which contains standard elements, such as Operator Support System (OSS), Home subscriber Service (HSS) and Service Fulfillment. This platform has communication with the GQ-eUICC through the ES6 standard communication interface.

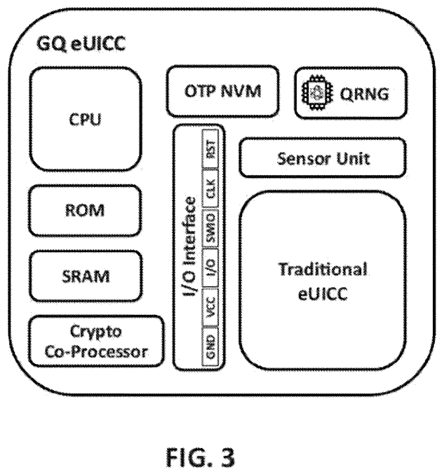

As explained before, the present invention also relates to a new type of eUICC card, called GQ-eUICC, and shown in FIG. 3. The GQ-eUICC card serves as a client device to remote provisioning services, provided by QDS/QDP+ logical entities (203).

The GQ-eUICC card comprises post-quantum cryptography capabilities and implements the new security method of the present innovation. This GQ-eUICC card is compatible with the requirements of a traditional eUICC card, although internally it has differences.

The GQ-eUICC corresponds to a card as described in FIG. 3. The GQ-eUICC comprises a processor (CPU), a ROM, a synchronous memory (SRAM), a QRNG element (randomness generator), a Sensor Unit (sensors), an input and output interface (I/O interface), and a standard eUICC embedded internally and/or connected directly and uniquely to GQ-eUICC pins.

The processor (CPU) could comprise also a cryptographic co-processor dedicated for performing cryptographic calculations.

The hardware footprint of the GQ-eUICC varies depending on its format, it may have a standard eUICCs pinout in MFF2 or may be incorporated into the user device processor system (101) as an integrated UICC (iUICC).

In some embodiments, the design of GQ-eUICC contains a series of physical connections to insert physically a standard eUICC in MFF2 format (8-pin chip), the GQ-eUICC will communicate protected by the post-quantum communication channels and tunnels previously described. The connector format as well as the position of this eUICC are variable to the GQ-eUICC format.

Generic components, such as CPU, ROM, SRAM or cryptographic co-processor, can be contained within a partially reconfigurable unit or be static, operating on a 32-bit ARM architecture and with a RAM of at least 1 Mbyte of usable space.

In particular, the GQ-eUICC is compatible with different post-quantum schemes, having the ability to execute within 300 ms an authentication and a key exchange cycle using code-based algorithms, such as QC-MDPC (Quasi-Cyclic Moderate Density Parity-Check) algorithms, or Lattice-based algorithms, among other algorithms.

The GQ-eUICC communicates with its eUICC using the I/O interface. This interface comprises physical pins to connect the eUICC in MFF2 formats, maintaining the standard pin nomenclature of eUICC. This pin nomenclature is GND, SWIG, I/O, VCC, RST and CLK.

The invention uses these parameters as a reference but is not limited to them. In the future this could include other capabilities and/or architectures beyond these specific ones, especially in the case of non-standardized, tailor-made solutions.

The GQ-eUICC design preferably includes a QRNG hardware random number generation module.

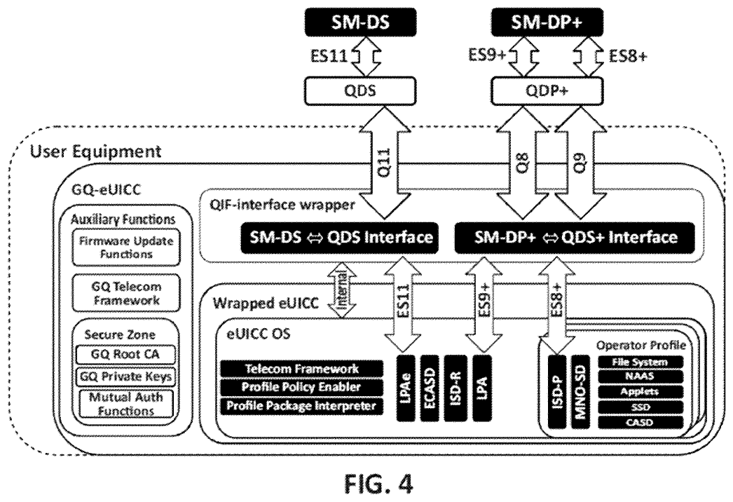

The interaction between logical and physical components can be seen in FIG. 4. The QDP+ and QDS logical components (203) as well as the GQ-eUICC card implement the QIF secure tunnel (202).

On this tunnel are defined communication interfaces called Q11, Q8 and Q9 (generally called Qx). These are originated in the GQ-eUICC when the base eUICC (which is connected by the I/O pins) establishes the ES11, ES9+ and ES8+ interfaces, following the mechanisms established by the standard.

The GQ-eUICC encapsulates the aforementioned interfaces (ESx) according to their interface type and destination, within the Qx interfaces, included in the new method. This process is performed in a QIF Interface Wrapper logical element, which resides within the GQ-eUICC. This logical module in conjunction with GQ Telecom Framework and Secure Zone auxiliary functions, establish the QIF tunnel (202) to the QDP+/QDS services (203), changing the underlying transport and security method associated with the ESx interfaces to post-quantum (Qx).

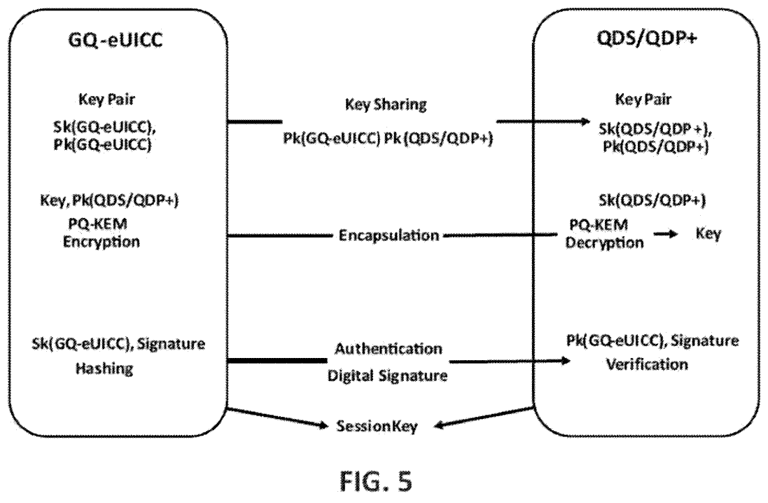

FIG. 5 shows a secure communication protocol between the GQ-eUICC and the QDS/QDP+ platform (203). In this case, a session key is created for connecting the GQ-eUICC and the QDS/QDP+ platform (203) in a secure way. For that, each entity is set with a key pair, comprising a secret key, sk(GQ-eUICC) and sk(QDS/QDP+), and a public key, pk(GQ-eUICC) and pk(QDS/QDP+). The public keys (pk) are shared between each other over Internet, i.e. a public channel.

For establishing a secure key exchange, GQ-eUICC uses a Post-Quantum Key Encapsulation Mechanism (PQ-KEM) with the public key (pk) of QDS/QDP+ platform (203) to encrypt its secret key, sk(GQ-eUICC). The QDS/QDP+ platform (203) decrypts the encapsulated secret key, sk(GQ-eUICC), with its secret key, sk(QDS/QDP+).

For authentication, the GQ-eUICC signs a message with its secret key, sk(GQ-eUICC), and QDS/QDP+ platform (203) verifies the message with the public key of the GQ-eUICC, pk(GQ-eUICC). The same process is performed in both ways, i.e. bi-directionally.

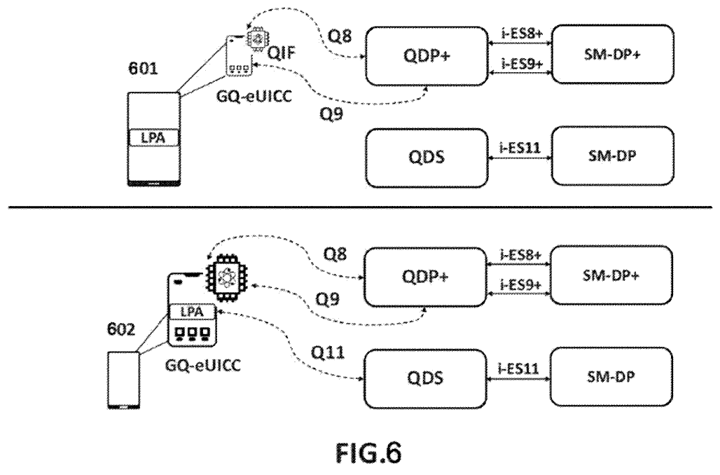

Two scenarios are covered by the new method as shown in FIG. 6:
The user devices (101) which initiates the provisioning process has an element called Local Profile Assistant (LPA) (601). In this case, the ES11 interface works in the traditional way.
The Local Profile Assistant (LPA) is included in the eUICC (602). In this case, the invention contemplates an interface called Q11 that enables secure communication through the QIF tunnel (202), where the ES11 interface travels encapsulated.

The QIF communication tunnel (202) is the logical element of communication wherein the Q8, Q9 and Q11 interfaces are established. In said interfaces the corresponding ES11, ES9+ and ES8+ travel. This communication channel is established directly between the QDP+/QDS logical components (203) and the GQ-eUICC element, through an IP protocol provided by the bearer of access to Wide Area Network (WAN) or Internet, either temporary or dedicated, such as a Bootstrap or WiFi connection.

The QIF tunnel (202) traverses from the user device (101) to the IP addresses (IPV4 and IPV6) corresponding to QDP+/QDS platform (203), which are preconfigured in the GQ-eUICC. These IP locations can reside outside the Local Area Network (LAN) or close to the Metropolitan Area Network or Wide Area Network (MAN/WAN), therefore crossing through public network to their destination.

The bearer is a standard element, which is handled by the GQ Telecom Framework element, belonging to the Auxiliary Functions module in the GQ-eUICC. This module, in the case of not achieving connectivity by itself, establishes the internal bearer of the embedded eUICC to access the communication layer provided by the eUICC.

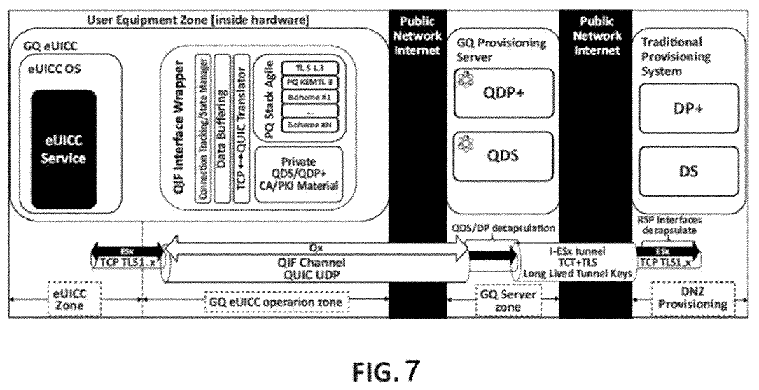

FIG. 7 shows the interaction of the modules from the user device (101) to the provisioning system, connecting the User Equipment zone, through a public network with the GQ Provisioning Server, and then, the GQ Provisioning Server is connected through a public network with a traditional provisioning system.

Initially, the eUICC module initiates a connection request, generating ESx interfaces.

Subsequently, the QIF Interface Wrapper of the GQ eUICC establishes a QIF post-quantum encrypted tunnel (202), wherein the ES8, ES9 and/or ES11 interfaces generated are encapsulated inside the QIF tunnel (202) completely and without modifications, neither in header nor in payload. Therefore, the content of the corresponding IP packets (ES8, ES9 and/or ES11) remain intact, including their headers and all payloads.

This encapsulation and an enrichment of headers, necessary to be transported over the QIF tunnel (202), are carried out in a TCP-QUIC Translator module of GQ-eUICC and in the QDS/QDP+ logical element (203), in its connectivity layer.

The QIF tunnel (202) is decomposed into multiple layers, starting with the most basic as a User Datagram Protocol (UDP) over IP channel, which through Quick UDP Internet Connections (QUIC) protocol establishes a tunnel with private IP QUIC UDP headers. Also, the traffic that crosses this tunnel goes through an authentication mechanism and a key exchange mechanism, KeyExchange or Key Encapsulation Method, corresponding to the category Post Quantum, which are provided by the elements described in the QIF Interface Wrapper module, in PQ Stack Agile section. For example, the mechanisms are Bit Flipping Key Encapsulation based on QC-MDPC, or Code-Based authentication, etc.

The QIF tunnel (202) extends from the GQ-eUICC module to its corresponding QDP+/QDS platform (203) endpoint, which reside within the GQ Provisioning Server module. This communication over the QIF tunnel (202) can traverse both public and private networks interchangeably. For example, purposes FIG. 7 shows a large public area called Public Network Internet.

Likewise, the QIF mechanism is not limited only to what is described in specific above, being possible its extension towards non-standardized post-quantum category schemes, through an internal component called Firmware Update Functions, which implements an internal protocol both in the GQ-eUICC card and in the QDS/QDP+ logical elements (203) to allow remotely updating the cryptographic primitives through Over-the-air (OTA) and/or via Quick UDP Internet Connections (QUIC). The update is managed and handled by the QDS/QDP+ logical elements (203), at a communications layer.

Once the session keys are established, symmetric encryption is initiated, being based on some algorithm such as AES, Snow5G, Snow3G but not limited to these.

The cryptographic material necessary to authenticate the QDS/QDP+ platform (203) and to exchange keys with GQ-eUICC card resides in the Secure Zone element of the GQ-eUICC card. The Secure Zone element corresponds to an element of the Secure Element type where it is not possible to access directly, only through APIs, and its writing is subjected to cryptographic control and permissions established during the manufacturing process.

As part of the new method, a logical tunnel of communications is established from the QDS/QDP+ logical elements (203) of the GQ Provisioning Server module to the SM-DP+ and SM-DS services (206) of a Traditional Provisioning System module. Thus, the QDP+/QDS logical elements (203) are the terminators of the QIF tunnel (202), which carries the interfaces Q8, Q9 and Q11, being the encapsulated form of their counterparts ES8, ES9 and ES11.

The i-ESX logical tunnel (205) is established using IP over Transmission Control Protocol (TCP) plus a traditional Transport Layer Security (TLS) layer for key setting, authentication and symmetric encryption, but using 24-hour (TTL, Time to Live) keys.

Also, this tunnel can be deployed via Internet Protocol security (IPsec) instead of TLS, maximizing the security chain. Both options (TLS and IPSEC) are used to decrease key renegotiations, thus decreasing events susceptible to quantum violation. This logical tunnel crosses either public or private networks indistinctly, in our example, there is a single crossing over public network, protected as explained.

This configuration also enables transparent communication with traditional suppliers, without requiring other logical pieces of adaptation.

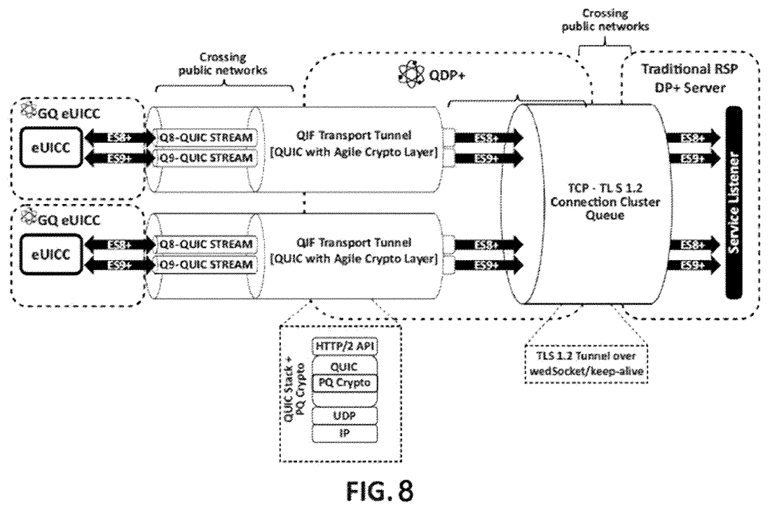

Interfaces Q8, Q9 and Q11 are opened in the GQ Provisioning Server module, to be de-encapsulated, obtaining the original messages from interfaces ES8, ES9 and ES11 originated in the eUICC module. These interfaces are then routed inside the new i-ESX tunnel (205), where they find their final destination in the SM-DP+ and/or SM-DS services (206) correspondingly, as shown in FIG. 8.

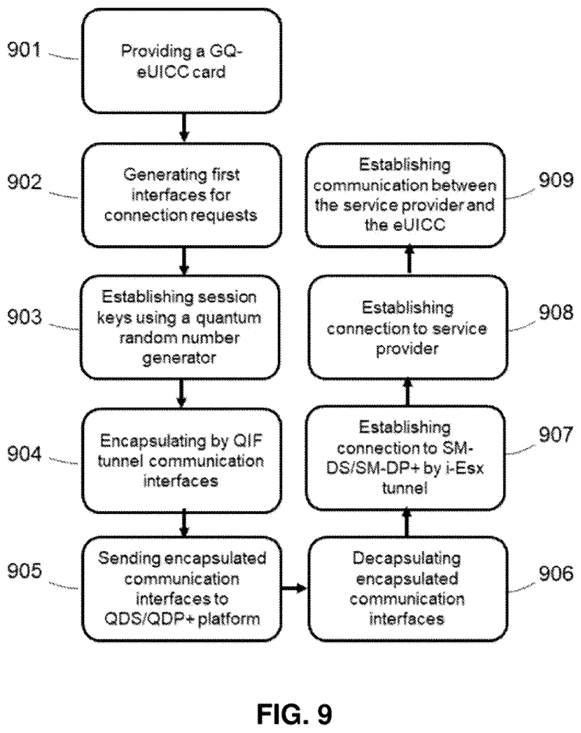

FIG. 9 shows a flow diagram of an exemplary embodiment of the method of the invention

Firstly, the method of the invention comprises a step of providing (901) a GQ-eUICC card according to the invention as previously described. The GQ-eUICC card, in this case, comprises a GQ-module, with post-quantum cryptography algorithms, an eUICC card, connected via pins of an I/O interface to the GQ-module and a quantum random number generator.

Then, the user device (101) performs a connection request to the subscription of services, which could be initiate remote provisioning operation through the local profile assistant (LPA) or obtain the status of his subscription or other operation that requires communicating with the SM-DP/SM-DS+ services (206), interacting with the LPA.

For that, the eUICC card generates (902) one or more first interfaces, in this case ES8, ES9 and ES11, in response to the connection request.

Session keys are established (903) by using post-quantum algorithms as shown in FIG. 5. Then, a QIF tunnel (202) is established between the GQ-eUICC card and the QDS/QDP+ platform (203). A message and the first interfaces are encapsulated (904) completely and without modifications by means of the QIF tunnel (202) established, thus obtaining encapsulated communication interfaces, secure against classic and quantum computing The encapsulated communication interfaces are sent (905) to the QDS and/or QDP+ provisioning platform (203), through an IP protocol provided by a WAN or Internet access carrier. The QDS/QDP+ provisioning platform (203) decapsulates (906) the encapsulated communication interfaces, thus obtaining the first interfaces from the encapsulated communication interfaces.

Then, a connection between the QDS/QDP+ platform (203) and the SM-DP+ and/or SM-DS subscription servers (206) is established (907) using an i-ESx (internal-ESx) tunnel (205) based on symmetric exchange, which encapsulates the first interfaces and transmits the said first interfaces encapsulated.

Therefore, when encapsulated requests are received in the QDS/QDP+ platform (203), they are queued at a synchronization point and transferred from the QIF tunnel (202) to the i-ESX tunnel (205).

More requests could be made in parallel or serial. In this case, all are encapsulated by the GQ-eUICC card and then queued and transferred from QIF tunnel (202) to the i-ESX tunnel (205).

One or more second interfaces are generated for establishing (908) a communication between the SM-DP+ and/or SM-DS subscription servers (206) and a service provider (207) containing OSS (Operator Support System), HSS (Home subscriber Service), or Service Fulfillment elements.

Then, using one or more third interfaces, a secure communication is established (909) between the service provider (207) and the eUICC for service provisioning.

The QIF tunnel (202) is active based on the maximum lifetime selected per LPA session or until the LPA logs out directly, which destroys the QIF tunnels (202).

i-ESX tunnels (205) are independent of the GQ-eUICC and do not correspond to the QIF status or the eUICC status.

Thus, the method of the invention allows to transfer in a post-quantum secure way, a profile assigned by the provisioning operator, offering connectivity to an authorized MNO, so that the user can receive service in his user device (101).

1. Remote service provisioning method for embedded universal integrated circuit cards eUICC, to provide secure communication against quantum computing attacks, wherein the method comprises the steps of:
providing (901) a GQ-eUICC card (101) comprising a GQ-module, comprising post-quantum cryptography algorithms, and an eUICC card, connected via pins of an I/O interface to the GQ-module,
generating (902), by the eUICC card, one or more first interfaces in response to connection requests either from or to SM-DP+ and/or SM-DS service subscription servers (206);
establishing (903) session keys by means of post-quantum algorithms;
encapsulating (904) a message and the first interfaces completely and without modifications by means of a QIF tunnel (202), generated by the GQ-eUICC card using post-quantum cryptography algorithms, leading to encapsulated communication interfaces, secure against classic and quantum computing;
sending (905) the encapsulated communication interfaces to a QDS and/or QDP+ provisioning platform (203), through an IP protocol provided by a WAN or Internet access carrier;
decapsulating (906) the encapsulated communication interfaces in the QDS and/or QDP+ provisioning platform (203), obtaining the first interfaces from the encapsulated communication interfaces;
establishing (907) a connection between the QDS and/or QDP+ provisioning platform (203) and the SM-DP+ and/or SM-DS subscription servers (206) using an i-ESx (internal-ESx) tunnel (205) based on symmetric exchange, which encapsulates the first interfaces and transmits said first interfaces encapsulated;
establishing (908) through one or more second interfaces a communication between the SM-DP+ and/or SM-DS subscription servers (206) and a service provider (207) containing OSS (Operator Support System), HSS (Home subscriber Service) or Service Fulfillment elements; and
establishing (909) through one or more third interfaces a secure communication between the service provider (207) and the eUICC.

2. Remote service provisioning method according to claim 1, wherein the GQ-eUICC card provided also comprises a quantum random number generator configured to provide randomness in the step of generating (903) session keys by means of post-quantum algorithms.

3. Remote service provisioning method according any of previous claims, wherein the step of generating (902) one or more first interfaces in response to connection requests from or to SM-DP+ and/or SM-DS service subscription servers (206) is carried out by means of an LPA (Local Profile Assistant) included in the eUICC card or in a user device comprising the eUICC card, using the first encapsulated interfaces that enables secure communication through the QIF tunnel (202).

4. Remote service provisioning method according to claim 3, further comprising a step of generating one or more encapsulated interfaces from the one or more first interfaces, that enables secure communication through the QIF tunnel (202), in response to connection requests from the eUICC card to the QDS and/or QDP+ provisioning platform (203), and vice versa, being the eUICC card assisted by the LPA (Local Profile Assistant).

5. Remote service provisioning according any of previous claims, wherein the step of encapsulating (904) the interfaces by means of a QIF tunnel (202) is performed in a QIF Interface Wrapper logic element of the GQ-eUICC card.

6. Remote service provisioning method according to any of previous claims, wherein in the step of sending (905) encapsulated connection requests, the WAN or Internet access carrier is controlled by a GQ Telecom Framework logical element, comprised by an Auxiliary Functions module of the GQ-eUICC card.

7. Remote service provisioning method according to claim 6, wherein the WAN or Internet access carrier, in case of not achieving connectivity by itself, establishes connection using internal carriers of the embedded eUICC card.

8. Remote service provisioning method according to any of previous claims, wherein the QIF tunnel (202) is decomposed into multiple layers, using a UDP channel type over IP, and through a QUIC protocol establishes a tunnel with private QUIC UDP IP headers, also the traffic that crosses through this tunnel passes through post-quantum key exchange and authentication mechanisms provided by a QIF Interface Wrapper module of the GQ-eU ICC card, based on Code-Base or Lattice algorithms.

9. Remote service provisioning method according to any of previous claims, further comprising a step of remote updating of the cryptographic primitives through OTA and/or via QUIC, thus extending towards standardized and/or non-standardized post-quantum category schemes, by means of a Firmware Update Functions internal component of the GQ-eUICC card, administered and managed by the QDS and/or QDP+ provisioning platform (203).

10. Remote service provisioning method according to any of previous claims, wherein the symmetric encryption of the step of establishing (907) a connection between the QDS and/or QDP+ provisioning platform (203) and the SM-DP+ and/or SM-DS subscription servers (206) is based on an AES, Snow5G or Snow3G algorithm, once session keys are established.

11. Remote service provisioning method according to any of previous claims, wherein cryptographic material of the step of establishing (903) session keys by means of post-quantum algorithms, needed to authenticate the QDS and/or QDP+ provisioning platform (203) and to exchange keys with the GQ-eUICC card, is stored in a logical element of the GQ-eUICC, which corresponds to an element of the Secure Element type and cannot be accessed directly except through APIs and in which writing permissions are established during manufacturing and are subjected to cryptographic control.

12. Remote service provisioning method according to any of previous claims, where the i-ESX tunnel (205) is established using IP transport over TCP plus a traditional TLS layer in terms of key setting, authentication, and symmetric encryption, but using 24-hour duration keys.

13. Remote service provisioning method according to any of claims 1 to 11, where the i-ESX tunnel (205) is established using IP transport over TCP plus an IPSEC layer in terms of key setting, authentication, and symmetric encryption, but using 24-hour duration keys.

14. Embedded universal integrated circuit card GQ-eUICC comprising:
at least one eUICC card;
a GQ-module comprising:
at least one ROM;
at least one SRAM synchronous memory; and
at least one processor, connected to and controlling the at least one ROM, the at least one synchronous SRAM memory; and the at least one eUICC card, and configured to perform the method according to any of the claims 1 to 13; and
at least one I/O interface, which connects the eUICC card to the GQ-module.

15. Embedded universal integrated circuit card GQ-eUICC according to claim 14, wherein the eUICC card is embedded as an iUICC card.

16. Embedded universal integrated circuit card GQ-eUICC according to any of claims 14 to 15, further comprising at least one QRNG randomness generating element for the generation of secure cryptographic keys based on a physical detection of quantum states and connected to the at least one processor; and comprising at least one sensor, configured to detect a quantum state, connected to the at least one QRNG randomness generating element.

17. Embedded universal integrated circuit card GQ-eUICC according to claim 16, wherein the QRNG randomness generating element is a generator based on photonic detection by detection of single photons or methods of calculating quantum entropy by light measurement.

18. Embedded universal integrated circuit card GQ-eUICC according to claim 16, wherein the QRNG randomness generating element comprises independent

19. device or semi-independent device strategies to decrease the chances of violation due to damage to the at least one sensor.

20. Remote service provisioning platform comprising a user device with an embedded universal integrated circuit card GQ-eUICC in accordance with claims 15 to 18, and a QDS and/or QDP+ provisioning platform (203) with a QRNG randomness generator for secure cryptographic key generation.
